(19) United States
(12) Patent Application Publication
(10) Pub. No.: US 2026/0008113 A1
(43) Pub. Date: Jan. 8, 2026

(54) METHOD AND DEVICE FOR PRODUCING SAWN TIMBER

(71) Applicant: Gebrüder Linck, Maschinenfabrik 'Gatterlinck’ GmbH & Co. KG, Oberkirch (DE)

(72) Inventor: Jörn Rathke, Oberkirch (DE)

(73) Assignee: Gebrüder Linck, Maschinenfabrik 'Gatterlinck’ GmbH & Co. KG, Oberkirch (DE)

(21) Appl. No.: 18/945,765

(22) Filed: Nov. 13, 2024

(30) Foreign Application Priority Data
Jul. 4, 2024 (EP) 24186481.8

(51) Int. Cl. B23D 59/00

(52) U.S. Cl. CPC B23D 59/002

(57) ABSTRACT

A method for producing sawn timber from a log, includes: determining a first cutting solution for the log having a spatial arrangement of side and main products; processing the log by cutting according to the cutting solution, producing an essentially planar surface of the main or side product; quality inspecting the surface to determine a defect in the wood and/or a property of the defect in the wood; determining a second cutting solution depending on the identified defect and/or the property of the defect, in which the main and/or side product is subdivided with respect to the first cutting solution into at least two main product boards and/or two side product boards and/or a subdivision of at least two main product boards or two side product boards is modified with respect to the first cutting solution; and processing the log by cutting based on the second cutting solution.

### CROSS-REFERENCE TO RELATED APPLICATIONS

This application claims priority from European Patent Application No. 24186481.8, filed Jul. 4, 2024, which is incorporated herein by reference as if fully set forth.

### TECHNICAL FIELD

The invention relates to a method and to a device for producing sawn timber from a log.

### BACKGROUND

In industrial timber processing, logs are processed to produce boards, inter alia, it being desirable to achieve the highest possible timber yield. To do this, a log to be processed is usually examined in terms of its geometry and a so-called cutting solution is identified. This specifies a possible arrangement of boards with regard to a log geometry. By processing the log according to this cutting solution, it is intended that the desired high timber yield is achieved.

The cutting solution is usually determined by the log being scanned by means of a profile sensor during an advancing movement. A log geometry is identified from the measured data thus obtained and, on the basis thereof, an arrangement of the boards to be obtained. So-called main product boards are here typically situated in an inner cross-sectional area of a log, whilst side product boards are arranged in an outer cross-sectional area compared thereto.

One challenge associated with this is that the log can have different quality defects which are not outwardly visible and cannot be taken into account when calculating the cutting solution on the basis of an outer log geometry. Although the log is thus processed according to the cutting solution and an in principle high timber yield is hence achieved, it is absolutely possible that boards are also produced which do not have the desired quality.

### SUMMARY

The object of the invention is to provide means by which the processing of a log is possible with a good timber yield, the boards produced having the required quality.

The object is achieved by means of a method having one or more of the features disclosed herein and a device having one or more of the features disclosed herein. Advantageous developments are described below and in the claims.

The method according to the invention is used to produce sawn timber from a log and comprises the following method steps:
A) Determining a first cutting solution for the log which comprises a spatial arrangement of side product boards and main product boards;
B) Processing the log, by cutting it, according to the first cutting solution, wherein an essentially planar surface of the main or side product boards is produced;
C) Inspecting the quality of the surface in order to determine at least one defect in the wood and/or a property of the defect in the wood;
D) Determining a second cutting solution depending on the identified defect in the wood and/or the property of the defect in the wood, wherein at least one area of the main product or the side product is subdivided with respect to the first cutting solution into at least two main product boards and two side product boards and/or a subdivision of at least two main product boards and at least two side product boards is modified with respect to the first cutting solution;
E) Processing the log, by cutting it, according to the second cutting solution.

The method according to the invention is based on the insight that the log can be subject to a quality inspection after the surface of the main product boards or side product boards have been produced in order to determine a second cutting solution by means of which a good timber yield and the desired quality can be obtained with respect to the first cutting solution. This results in particular from the fact that defective areas of the main product boards or the side product boards do not have to be eliminated and instead are subdivided into a plurality of main or side product boards solely depending on the detected defect in the wood and/or a property of the defect in the wood or an already existing subdivision of the first cutting solution is modified.

It is relevant that the determination of the second cutting solution is effected depending on the defect in the wood and/or the property of the defect in the wood. This aspect is based on the insight that the quality and hence also the attainable trade price of a main or side product board can essentially depend on whether it has defects in the wood, how many of the latter there are, or for example how pronounced they are. This is relevant for the invention in that the optimization described here of the first cutting solution by determining the second cutting solution can comprise a reduction of the width of a main product board or a side product board, which usually entails economic losses.

However, economic analyses have surprisingly found that the trade value of a main or side product board can advantageously be increased if, despite relatively narrow dimensions, in particular widthwise, it is produced on a quality basis. In particular, the attainable trade price of such a main or side product board can increase, because of the reduction of defects in the wood, more than it decreases because of a reduced dimension, in particular widthwise. At the same time, the in each case other one of the subdivided main or side product boards which has a lower quality can be provided for purposes in which high quality is not absolutely necessary, such that economic advantage can also be obtained hereby.

It is in principle irrelevant for performing the method according to the invention whether the surface inspected in method step C) is to be associated with a main product board or a side product board. The above-described advantages can thus be achieved independently of whether the determination of the second cutting solution comprises a subdivision of the main or side product boards. It is, however, advantageous that, after the quality of the surface of the main product has been inspected, it is subdivided into at least two main product boards and/or a subdivision according to a first cutting solution is modified. Similarly, it is advantageous that, after the surface of the side product has been inspected, this side product is subdivided into at least two side product boards and/or a subdivision according to the first cutting solution is modified. In other words, the main product can according to the first cutting solution comprise at least one first main product board which is subdivided into at least a second and a third main product board according to the second cutting solution. Accordingly, the side product can according to the first cutting solution comprise a first side product board which is subdivided according to the second cutting solution into at least a second and a third side product board.

Method step A) can be performed by the log being moved in a direction of advance and thus passing into a capturing range of one or more profile sensors and traveling through it. The profile sensor can be a laser light section sensor or a comparable sensor by means of which it is possible to identify three-dimensional data which at least partially represent the log geometry. In particular, the profile sensor can be positioned stationarily with respect to the direction of advance of the log. The log geometry is preferably identified depending on the speed of advance of the log.

The identified log geometry can be present in the form of a three-dimensional model, in particular on the basis of a point cloud, with the aid of which in particular one or more cross-sectional profiles of the log can be derived. The first cutting solution identified in method step A) is preferably based on the identified log geometry and specifies how the main product and the side product and in particular main product boards and side product boards included therein are arranged with respect to the log and the identified log geometry. In particular, according to the first cutting solution the main product can include one or more main product boards and the side product one or more side product boards. In particular, the plurality of main product boards and/or the side product boards can in each case be present in stacks. According to the first cutting solution, at least two main product boards or at least two side product boards can also be arranged in pairs in a common plane which runs essentially parallel to the respective lateral sides of the main and side product boards. It is also within the scope of the invention that the first cutting solution which is identified in method step A) does not include a subdivision of the main or side product boards and only specifies a possible arrangement of main and side product boards with respect to the log which can be subdivided in particular in method step D) in order to define the dimensions and arrangements of main product boards and side product boards to be obtained with respect to the log.

Method step B) can be performed by a slab area being cut from the log in one piece by means of a saw cut or, for example, by means of milling, by the slab area being cut up into wood chips. The only relevant thing is that, as a result of method step B), at least one straight side can be produced which forms the surface of the main or side product which is situated on the log. In particular, the surface of the main or side product is a long lateral side of at least one main product board or at least one side product board. As explained above, such a main or side product board can be included in the first cutting solution which has been identified in method step A).

It is within the scope of the invention that one or more planar surfaces are produced in method step B). In particular, the log can, after method step B) has been performed, be present as a so-called cant or a model which has two or four sides which are distributed on all sides of the cant or the model and are separated from one another in particular in pairs by a waney edge area. It is within the scope of the invention that the surface of the main or side product in method steps B) and C) is not the final surface of main product boards or side product boards to be produced such that the latter can be further processed, for example by means of planing, in particular after method step D).

Method step C) comprises the quality inspection of the surface of the main or side product. This can be effected by means of one or more optical inspection systems which are in each case configured to identify two- and/or three-dimensional image data of the surface of the main or side product.

In particular, in the case of the quality inspection according to method step C), a geometric profile is captured and/or a two-dimensional inspection image is captured. The geometric profile can specify a three-dimensional geometry at the surface of the main or side product and be identified in particular depending on the speed of advance of the log. In particular, the optical inspection system can comprise a profile sensor which is designed in particular as identical or at least comparable to the profile sensor which can be used for calculating a log geometry. The inspection image can comprise in an image plane a two-dimensional distribution of grayscale values and/or color values, in particular of the colors red, green, and blue. In particular, the two-dimensional data do not comprise the course of the profile of the surface which extends perpendicularly to the surface. The optical inspection system is preferably arranged with respect to the log in such a way that a depth of field which runs in particular parallel to a focal plane of the optical inspection sensor extends, whilst the method step C) is being performed, essentially parallel to the inspected surface of the main or side product.

A defect in the wood can comprise a branch and/or a knothole and/or a split and/or warping and/or discoloration and/or rot and/or sapwood and/or insect infestation. A property of the defect in the wood can describe a manifestation of a defect in the wood, in particular one of the above defects, for example a spatial position and/or its spatial spread on the surface of the main or side product.

Method step C) can comprise a data processing step by means of which the image data collected during the imaging inspection are evaluated in order to identify the defect in the wood and/or the property of the defect in the wood. It can preferably comprise image processing in which in particular filtering and/or edge detection and/or segmentation and/or a morphological operation and/or feature extraction and/or pattern recognition and/or pattern classification and/or texture analysis and/or histogram analysis is performed in order to capture the defect in the wood and/or the property of the defect in the wood. It is moreover within the scope of the invention that a data processing step comprises the use of an evaluation algorithm on the basis of artificial intelligence and/or machine learning.

Method step D) comprises determining the second cutting solution which comprises a different manifestation of the main or side product than the original first cutting solution. A main product board or a side product board defined in the first cutting solution can here be subdivided into at least two main product boards and two side product boards or, for example, two already subdivided adjacent main product boards or side product boards can be modified in terms of their size ratios, in particular a width ratio, or for example their respective positions with respect to the log. In particular, the main or side product is subdivided into at least two main or side product boards in such a way that a separating plane is defined essentially orthogonally to the inspected surface of the main product or side product or a subdivision between two main product boards or side product boards is modified by such a separating plane being shifted, in particular offset in parallel, such that in particular the widths of the main or side product boards are modified.

Processing the log by cutting it according to method step E) is effected according to the second optimized cutting solution determined in method step D) and comprises in particular the production of the subdivided main and side product boards. Two waney edge areas adjoining the surface of the main or side product can here be milled off and the subdivided main or side product boards can be separated from one another or from the log by means of one or more saw cuts.

In an advantageous development, in method step C) the defect in the wood on the surface can be identified, spatially resolved and by determining a position and/or spatial spread of the defect.

Spatially resolved identification of the defect in the wood makes it possible to determine a position of the defect in the wood with reference to the log or the identified log geometry and in particular to derive the second cutting solution depending thereon. In a simple embodiment, an optical inspection system which can be used in method step C) can be calibrated in such a way that the position and/or spread of the defect on the surface can be identified directly on the basis of the collected inspection data, in particular with reference to the log geometry.

In an advantageous development, the defect in the wood, in particular a position and/or spread of the defect with respect to the log, can be identified, spatially resolved, depending on a waney edge and/or a waney edge area which in each case borders the surface of the main or side product. The waney edge and/or the waney edge area is here captured before and/or during the method step C).

The above-described development is based on the insight that the waney edge and/or the waney edge area on the log, in particular also on the cant or on the model, can be used to simplify the spatially resolved identification of a defect in the wood and/or a property of the defect in the wood with reference to the log, in particular also with reference to the cant or model. The waney edge here refers to the course of a profile along the log axis which is created by the processing of the log, by cutting it, in method step B) and here directly laterally borders the surface of the main or side product. The waney edge area directly adjoins the waney edge and here refers to an external geometry of the log caused by the natural growth of the log, or in particular to areas thereof in the case of a cant or model. Both the waney edge and the waney edge area can, because of the individual growth of a log, have a correspondingly individual course which can be used as a spatial reference for a defect in the wood and/or a spread of a defect in the wood with respect to the log or cant or model.

In particular, the waney edge and/or the waney edge area can be included in the log geometry which can be identified for method step A) such that they can be used as a reference on the basis of which the position and/or spread of the defect can be determined with reference to the log or the log geometry or to the cant or model. Therefore, a log geometry identified before and/or during method step A) is advantageously used to determine the first cutting solution, which log geometry comprises the waney edge and/or the waney edge area.

In particular, a comparison is made in method step D) between a three-dimensional course of the waney edge area, which profile is included in the identified log geometry for method step A) and is included in an inspection result of a three-dimensional inspection of method step C). Depending thereon, the position and/or spread of the defect can be determined accurately with reference to the log, in particular also the cant or model.

Additionally or alternatively, in method step D) a comparison is made between a two-dimensional course of the waney edge which is included in a profile section of the identified log geometry for method step A) and is included in an inspection result of a two-dimensional inspection of method step C). In particular, the profile section extends essentially parallel to the log axis. Depending thereon, the position and/or spread of the defect with reference to the log, in particular also the cant or model, can be determined accurately.

In an advantageous development, an optical measurement device or a plurality of different optical measurement devices is or are used before and/or during method step C) for the imaging inspection of the surface of the main or side product and in order to identify the waney edge and/or the waney edge area.

In one conceivable embodiment of the above-described advantageous development, the optical measurement device can comprise an imaging camera which captures both the surface of the main or side product and the adjoining waney edge and/or waney edge area. As a result, a single surface image can be used to identify the capturable defects in the wood, spatially resolved, and their position and spread with reference to the log geometry with a high degree of accuracy, in particular depending on the waney edge and/or waney edge area. In particular, the at least one optical measurement device can be configured to inspect the surface of the main or side product only two-dimensionally and thus in particular provides no information about the geometric profile of the inspected surface.

In another conceivable embodiment, a plurality of optical measurement devices, separated from one another, can be used to capture the surface of the main or side product and the waney edge and/or waney edge area. It is consequently possible to optimize the optical measurement devices in each case in terms of the measurement task to be performed. In particular, the measurement devices can have a relative position to one another by means of which the captured waney edge or waney edge area and the surface image can be spatially correlated. In particular, it is within the scope of this embodiment that the waney edge and/or waney edge area are identified by means of a profile sensor and the surface of the main or side product are inspected by means of an imaging sensor. It is here possible that the profile sensor at least partially captures the surface but the profile data collected hereby of the surface are not used for the quality inspection.

In an advantageous development, method step D) is performed depending on a defect-related quality parameter, in particular in such a way that after method step D) at least one of the subdivided main or side product boards differs in terms of one or more defects in the wood and/or properties of the defects in the wood from the in each case other one of the subdivided main and side product boards. The subdivided main and side product boards preferably differ in their respective quality parameters. It is also within the scope of the advantageous development that the main or side product boards are subdivided in such a way that they do not differ in terms of the quality parameter. This can be advantageous, for example, when the total number of detected defects on the surface of the main or side product can be apportioned evenly to the subdivided main and side product boards by a subdivision according to the second cutting solution such that there is a desired ratio of the number of defects or a property of the defects in the wood to a width dimension of one of the subdivided main or side product boards. In particular, the main and/or side product board can be subdivided in such a way that at least one of the subdivided main and/or side product boards has at least one defective area.

The quality parameter can be considered as at least one characteristic value which includes information about to what extent a quality-related property is manifested on the surface of the main or side product or one of the subdivided main or side product boards. In particular, the surface of the main or side product can have a first quality parameter before method step D) and the subdivided main and side product boards in each case have a second quality parameter.

The advantageous development is not limited to the way in which the quality parameter is defined. It is conceivable that the quality parameter can be defined depending on the user or equipment and is thus dependent on the defect in the wood and/or the property of the defect in the wood. In particular, it can be a code which specifies whether defects in the wood are present and/or how pronounced the property of the defect in the wood is.

In particular, a plurality of quality parameters can be identified for performing method step D), in particular spatially resolved with reference to the inspected surface in method step C).

The quality parameter can preferably refer to the surface of the main or side product from method step C) and thus specify, for example, a ratio between a number of detected defects in the wood and/or a property of the defects in the wood and a dimension of the surface.

In particular, for performing method step D) a threshold value can be defined that a quality parameter must not exceed or fall below in order to carry out a subdivision of the main or side product and in particular to fix the dimensions and positions of the subdivided main and side product boards according to the second cutting solution.

In one simple example, the quality parameter can thus be a number of defects in the wood which are identified on the surface of the side product in method step C), wherein a threshold number of defects in the wood is exceeded. It is conceivable that the subdivision of the main or side product according to the second optimized cutting solution is then made in such a way that one of the main or side product boards does not have any defects in the wood and the in each case other side product board has all the detected defects in the wood.

It is also conceivable that the subdivided main or side product boards do not differ in terms of the number of defects in the wood. This is based on the insight that a separating cut can result in increased value compared with a larger board that is not subdivided, although the main or side product boards can be assigned to the same quality classifications after they have been subdivided or can be characterized by the same quality parameters.

A defect density, defect position, or defect type can also be used to identify the abovementioned quality parameter, wherein it is also in principle irrelevant how the latter is determined and in what fashion it is taken into account when subdividing the main or side product.

In an advantageous development, in method step C) the identified defect in the wood is formed at least partially by a branch which extends from the surface at least through the main product or the side product.

In particular, the identified defect in the wood can comprise a branch cross section or a part thereof and/or comprise a branch growth position. Within the scope of the invention described here, the term “branch” can describe a part of a log which extends within the log or cant, in particular from the surface of the main product or side product into the inside of the log.

Studies have shown that a branch constitutes a defect in the wood which, although the defect has an impact on the quality of a board and hence also its economic value, a main or side product board which is affected by growth of a branch does not necessarily have to be eliminated and excluded from the further processing. Rather, it is advantageous also to further process main or side product boards affected by growth of a branch in a value-adding fashion. Although the latter generally have a lower quality than boards which are not affected by branch growth, they can nevertheless be suitable for technical purposes in which relatively low requirements are placed on their quality.

In an advantageous development, in method step B) at least one first side product board is cut from the log according to the first cutting solution and a planar surface of the side product is consequently created on the log on which at least method step C) is performed.

According to the above-described development, the side product can comprise, according to the first cutting solution from method step A), a stack of a plurality of side product boards. Processing the log, by cutting it, in method step B) here takes place by removing not only a slab area of the log but also a side product board or the side product stack, as a result of which the surface of the side product board, situated below it, of the side product stack is exposed and inspected in method step C). The side product board inspected in method step C) is subdivided in method step D) into two side product boards and the latter are then cut from the log in method step E).

It has been found that the first side product board of a side product stack generally has smaller dimensions, in particular widthwise, than the side product boards situated below it. The reason for this is that the log width decreases in a radial direction because of a round cross section such that side product boards situated on the outside have correspondingly smaller widths. From an economic point of view, it is therefore not worthwhile to take these side product boards situated on the outside into account for a second optimized cutting solution. Although a subdivision of this first side product board could result in two board parts, one of which has fewer defects in the wood than the other in each case, the width dimension of the first side product board is, however, usually small such that a further subdivision into two board parts does not result in a significant economic advantage. In other words, it is advantageous that the second optimized cutting solution depending on the surface is not identified depending on a first side product board of a cutting solution of method step A) and instead on the basis of a side product board situated below it, in particular a second side product board.

In an advantageous development, in method step D) the main or side product is subdivided in such a way that a separating plane which runs essentially orthogonally to the surface of the main product or side product and subdivides the two main product boards or two side product boards is produced and/or shifted.

The separating plane specifies, as part of the second cutting solution according to method step A) or the second optimized cutting solution according to method step D), a spatial separation between two main or side product boards. The separating plane can in method step D) be a notional area in which the main or side product is subdivided in order to separate two main or side product boards from each other.

Preferably, in method step E) a scored line is produced on the side product which runs in particular along the separating plane, and then two side product boards separated from each other in this way are cut from the log by means of a separating cut. It is consequently possible in a simple fashion to perform the processing of the log according to the second optimized cutting solution. The subdivided main and/or side product boards produced and then separated preferably do not have to be processed further, in particular further subdivided. The scored line can be produced by means of a scoring saw which, when the log advances, engages with the log at the surface of the side product by cutting it, as a result of which the side product is subdivided spatially into at least two main and/or side product boards. In particular, the scored line is produced along a log axis over the whole length of the log.

As explained above, the object is also achieved by a device for producing sawn timber. The device comprises a delivery means which is provided to transport a log along its log axis in a main delivery direction and at least one profile sensor which is arranged in order to identify a log geometry during the delivery movement of the log. The device moreover comprises a data processor which is connected to the profile sensor by signals and is configured to calculate a first cutting solution depending on the log geometry. A first separating means is arranged and designed to engage with the log during the delivery movement by cutting it and to produce an essentially planar surface of the main or side product according to the identified cutting solution. At least one quality sensor is arranged in order to inspect the surface of the main or side product and is here configured to identify at least one defect in the wood and/or a property of the defect in the wood on the surface. The quality sensor and the data processor are connected to each other by signals, wherein the data processor is configured to identify a second cutting solution depending on the defect in the wood. The main or side product is here subdivided into at least two main product boards and two side product boards and/or a subdivision of the cutting solution of two main or side product boards is modified with respect to the first cutting solution. A second separating means is arranged and designed in order to engage with the log during the delivery movement, so as to cut it, and to process it according to the optimized cutting solution.

In particular, the device according to the invention is suitable for performing the method according to the invention or an advantageous development thereof. In particular, the method according to the invention or an advantageous development thereof can be performed by means of the device according to the invention or an advantageous development thereof. In this respect, the explanations regarding the above-described method apply correspondingly in terms of the conceivable embodiments of the device and the advantages which can be obtained therewith.

### BRIEF DESCRIPTION OF THE DRAWINGS

Advantages and possible embodiments of the invention are explained below on the basis of exemplary embodiments and the Figures, in which:

FIG. 1 shows the determination of a first cutting solution for a log;

FIG. 2 shows the profiling of a side product surface on the log according to the cutting solution;

FIG. 3 shows a quality inspection of the side product surface; and

FIG. 4 shows the determination of a second optimized cutting solution for the log, in which a side product board is subdivided.

### DETAILED DESCRIPTION

In industrial timber processing, logs are usually processed to produce boards which are obtained from different cross-sectional areas of the logs. Those boards which are obtained from a cross-sectional area of a log situated on the inside are referred to as main product boards. Boards which in contrast are obtained from a cross-sectional area situated on the outside are referred to as side product boards.

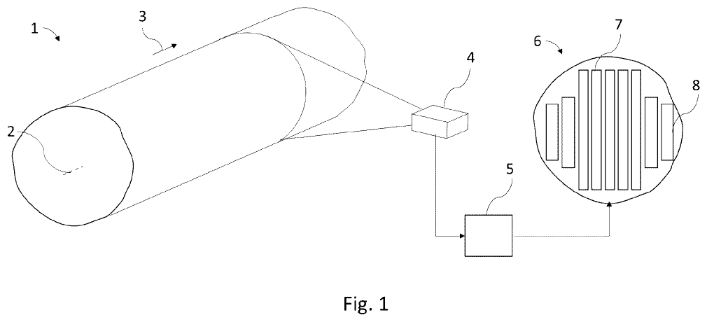

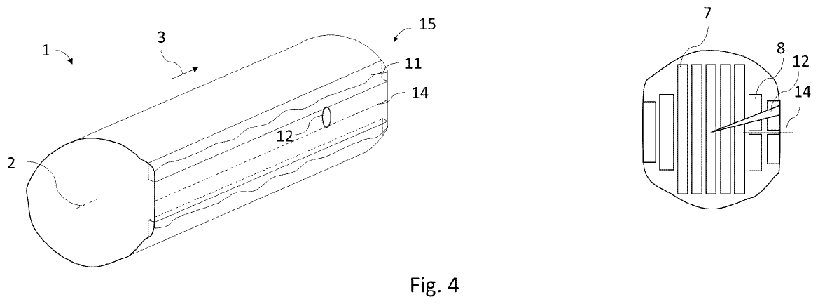

In order to achieve a good timber yield, a log is typically scanned by means of a profile sensor and a cutting solution is identified on the basis of the data thus obtained. This cutting solution specifies how the main and side product boards to be obtained are arranged with respect to the log geometry and what dimensions they have in order to achieve a good timber yield. In order to obtain the main and side product boards, the log is usually first processed according to the cutting solution to form a cant, as a result of which an essentially plane side is first produced which forms the planar surface of the side product so that the latter can be profiled on the log. The problem is that not all the defects in the wood can be identified on the basis of the profile data of the log and cannot be taken sufficiently into account when determining the cutting solution. This results in a high proportion of qualitatively low-value boards. A method and the means required to perform it are described on the basis of FIGS. 1 and 4 by means of which the desired quality of the boards which can be produced can be achieved with a simultaneously high timber yield.

FIG. 1 shows a log 1 which has an essentially cylindrical basic geometry which extends along its log axis 2. The log 1 has an irregular surface profile which is due to its natural growth. To process it, the log 1 is delivered in a direction of advance 3 and thus passes into a capturing range of a plurality of profile sensors 4, just one profile sensor 4 of which is shown in the exemplary embodiment shown here. The profile sensors 4 can by way of example take the form of laser light section sensors.

The data captured by the profile sensors 4 are communicated to a computing unit 5 which identifies a log geometry and a first cutting solution 6 dependent thereon, taking into account the relative movement between the log 1 and the profile sensors 4. The first cutting solution 6 includes, as indicated above, a plurality of main product boards 7 which are arranged in the cross-sectional area of the log 1 situated on the inside, and a plurality of side product boards 8 which are arranged in the cross-sectional area of the log 1 situated on the outside. For greater clarity, in each case only one main product board 7 and only one side product board 8 are provided with reference signs.

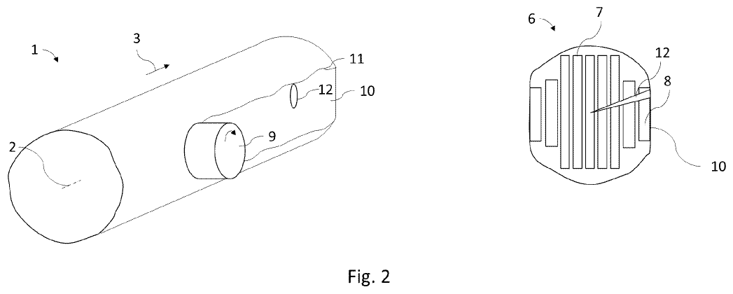

FIG. 2 shows the log 1 which is processed, by cutting it, in some areas according to the identified first cutting solution 6. Here, the log 1 is moved in the direction of advance 3 against a rotating milling head 9, as a result of which the latter engages with the log 1 in a separating fashion. A slab area is consequently cut from the log 1, as a result of which the surface 10 of a side product board 8 situated below it is produced. Instead of the milling head 9 shown in FIG. 2, a sawing means can also be provided by means of which the slab area of the log 1 is cut from the log 1 in one piece, as a result of which the surface 10 is created.

As a consequence of the processing of the log 1 shown in FIG. 2, two waney edges 11 are created which border the surface 10 of the side product board 8 and, in the exemplary embodiment shown here, extend essentially along the log axis 3. For the purpose of visibility, only one of the waney edges 11 is provided with a reference sign. On the other side of the waney edges 11, in each case a waney edge area of the log 1 extends which for greater clarity is not provided with a reference sign.

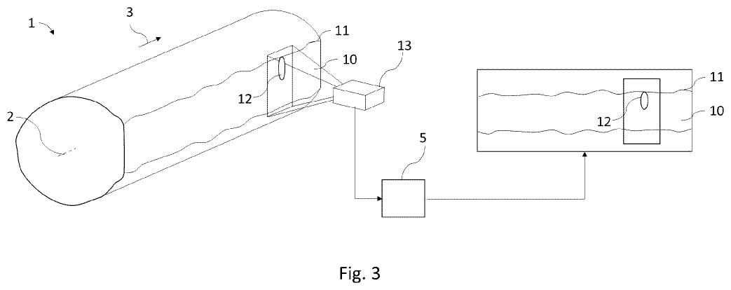

Removing the slab area and creating the surface 10 exposes a defect 12, which is a branch in the exemplary embodiment shown here, which extends, starting from the log interior, through the side product board 8 as far as its surface 10. Such a branch fundamentally diminishes the quality of the side product board 8 but, within the scope of the embodiment explained here, does not necessarily mean that the affected side product board 8 has to be eliminated and excluded from the further processing. Instead, as explained in detail on the basis of FIGS. 3 and 4, a branch growth position on the log is identified and an optimized cutting solution for the log 1 is thus determined.

According to FIG. 3, the log 1 which has been initially cut, which can also be present as a cant with two straight surfaces 10 or as a so-called model, is inspected by imaging. A camera system 13 is used for this purpose. It is relevant that, on the one hand, the surface 10 and, on the other hand, the waney edges 11 lie and are captured in the capturing range of the camera system 13.

In order to be able to determine a position of the defect 12 with respect to the log geometry, the camera system 13 can be calibrated in such a way that the position data can be determined depending on the position and movement of the log 1 and the image information and the recording time. In the embodiment shown here, the waney edge 11 or the waney edge area is also captured in addition to the surface 10, wherein the determination of the defect position with respect to the log 1 takes place depending on the course of a waney edge.

It is conceivable that a comparison is made between a two-dimensional course of the waney edge which is included both in the identified log geometry (cf FIG. 1) and in an inspection result of a two-dimensional inspection of the surface 10 (cf FIG. 3). Depending on this, the position and/or spread of the defect can be determined accurately with reference to the log (or cant or model), in particular by a comparison between a two-dimensional course of the waney edge which is included in a profile section of the identified log geometry and in a two-dimensional inspection image of the surface 10. In particular, the profile section extends essentially parallel to the log axis, as shown in the side view according to FIG. 3.

If, in addition to the camera system 13, a profile sensor (not shown) is used, the capturing of the surface 10 and the waney edge area can take place separately from each other, wherein the waney edge area is captured three-dimensionally and the surface 10 two-dimensionally. A waney edge area captured in this way can be compared with the identified log geometry (cf FIG. 1) and the position and/or spread of the defect can be accurately determined with reference to the log (or cant or model) depending on the relative position between the camera system and the profile sensor.

On the basis of FIG. 4, it is shown that an optimized cutting solution is determined depending on the position of the defect 12. The side product board 8, the surface 10 of which has been inspected by imaging, is hereby subdivided by means of a separating plane 14 which runs essentially perpendicular to the surface 10. The side product board 8 is consequently divided into two side product boards which differ from each other in the identified number of defects in the wood, specifically the branch explained here by way of example. The log 1 is then processed according to the optimized cutting solution. A scoring saw which subdivides the side product 8 according to the identified separating plane 14 is used for this purpose in a manner not shown in detail. Moreover, two waney edge areas 15 adjoining the side product are milled off, as a result of which the subdivided side product boards acquire essentially straight narrow sides running parallel to each other. The side product boards can then be cut from the log 1 by means of a saw cut.

The principle described here on the basis of FIGS. 1 to 4 of a subdivision of main or side product boards is based on the insight that the quality and hence also the attainable trade price of a main or side product board can depend essentially on whether the latter has defects in the wood, how many of these are present, or for example how pronounced they are. Although a reduction in the width of a theoretically obtainable main product board or a side product board usually entails economic losses, economic analyses have surprisingly found that the trade value of a main or side product board can advantageously be increased if, despite relatively narrow dimensions, in particular widthwise, it can be produced on a quality basis. In particular, the attainable trade price of such a main or side product board increases, because of the reduction in the defects in the wood, more than it decreases because of a reduced dimension, in particular widthwise. At the same time, the in each case other one of the subdivided main or side product boards which has a lower quality can be provided for purposes in which high quality is not absolutely necessary, such that economic advantage can also be obtained hereby.

Instead of performing the method as explained here, it is conceivable that, as part of processing the log, a side product board is first cut from the log, as a result of which the surface of a side product board situated below it is exposed and inspected by imaging. This is advantageous because the first side product board of a side product stack generally has a lower achievable width than a side product board situated below it. This means that side product boards situated on the outside correspondingly have smaller dimensions and from an economic point of view it is not worthwhile to take them into account for a second optimized cutting solution. The second optimized cutting solution can therefore not be identified on the basis of the surface of a first side product board and instead only on the basis of the surface of a side product board situated below it, in particular a second side product board.

In a manner which is likewise not shown, instead of the subdivision of the side product, the main product in the internal area of the log could also be subdivided into two main product boards. In contrast to the exemplary embodiment described here, the processing of the log 1, by cutting it, which is described in conjunction with FIG. 2, comprises not only the removal of a slab area but the whole side product. This can take place according to the above explanations of FIGS. 1 to 4 or without subdivision of the side product but by the latter being cut from the log according to the first cutting solution.

1. A method for producing sawn timber from a log (1), the method including the following steps:
A) determining a first cutting solution for the log (1) which comprises a spatial arrangement of side product boards and main product boards;
B) processing of the log (1), by cutting, according to the first cutting solution, wherein an essentially planar surface (10) of the main or side product is produced;
C) inspecting a quality of the surface (10) in order to determine at least one of i) a defect (12) in the wood or ii) a property of the defect in the wood;
D) determining a second cutting solution depending on the identified at least one of the defect (12) in the wood or the property of the defect in the wood, in which the main product or the side product is subdivided with respect to the first cutting solution into at least one of i) two main product boards and two side product boards (8) or ii) a subdivision of at least two main product boards or two side product boards (8) is modified with respect to the first cutting solution; and
E) processing of the log (1), by cutting, according to the second cutting solution.

2. The method as claimed in claim 1, wherein
in method step C) the defect (12) in the wood on the surface is identified and spatially resolved by determining at least one of a defect position or spatial spread of the defect.

3. The method as claimed in claim 2, further comprising
at least one of before or during method step C), capturing at least one of a waney edge or a waney edge area which in each case laterally borders the surface of the main or side product; and the at least one of the position or spread of the defect with reference to the log is identified and spatially resolved, depending on the at least one of the waney edge or the waney edge area.

4. The method as claimed in claim 1, wherein
method step D) is performed depending on at least one defect-related quality parameter.

5. The method as claimed in claim 1, wherein
at least two of the subdivided main or the side product boards (8) have at least one of different numbers of the defects, different defect densities, different defect positions or different defect types.

6. The method as claimed in claim 1, wherein
in method step C) the identified defect (12) in the wood is formed at least partially by a branch which extends from the surface (10) at least through at least one of the main product or side product.

7. The method as claimed in claim 1, wherein
the identified defect (12) in the wood is a branch cross section or a part of a branch cross section of the branch on the surface of the at least one of the main product or the side product.

8. The method as claimed in claim 1, wherein
in method step B) at least one first side product board (8) is cut from the log according to the cutting solution and the planar surface (10) of the side product is consequently created on the log (1) on which at least method step C) is performed.

9. The method as claimed in claim 1, wherein
in method step D) the main product or the side product is subdivided such that a separating plane (14) which runs essentially orthogonally to the surface (10) of the main or side product and subdivides the two main product boards or side product boards (8) is at least one of produced or shifted.

10. The method as claimed in claim 1, wherein
in method step E) at least one scored line is produced and the two or more of the main product or the side product boards are cut from the log (1) by a separating cut.

11. A device for producing sawn timber from a log (1), the device comprising:
a delivery device that transports the log (1) along a log axis in a main delivery direction (3);
a profile sensor (4) arranged in order to identify a log geometry during a delivery movement of the log (1);
a data processor (5) which is connected to the profile sensor (4) by signals and is configured to identify a first cutting solution depending on the log geometry;
a first separating device (9) arranged and designed to engage with the log (1) during the delivery movement to cut the log and to produce an essentially planar surface (10) of a main or side product according to the identified cutting solution;
a quality sensor (13) arranged to inspect the surface (10) of the main or side product and which is configured to identify at least one of a defect (12) in the wood or a property of a defect in the wood on the surface (10);
wherein the inspection sensor (13) and the data processor (5) are connected to each other by signals, and the data processor (5) is further configured to identify a second cutting solution depending on the defect (12) in the wood, in which the main product or the side product is subdivided into at least one of i) two main or side product boards (8) or ii) a subdivision of two main or side product boards of the first cutting solution is modified, and
at least one second separating device arranged and designed in order to engage with the log during the delivery movement, so as to cut the log and, to process the log according to the second cutting solution.
